(19) United States
(12) Patent Application Publication
(10) Pub. No.: US 2026/0087505 A1
(43) Pub. Date: Mar. 26, 2026

(54) Video Encoding Energy and Greenhouse Gas Emission Prediction

(71) Applicant: Bitmovin GmbH, Klagenfurt am Wörthersee (AT)

(72) Inventors: Christian Timmerer, Klagenfurt am Wörthersee (AT); Samira Afzal, Klagenfurt am Wörthersee (AT); Manuel Hoi, Klagenfurt am Wörthersee (AT); Armin Lachini, Klagenfurt am Wörthersee (AT); Farzad Tashtarian, Klagenfurt am Wörthersee (AT); Radu Prodan, Klagenfurt am Wörthersee (AT)

(73) Assignee: Bitmovin GmbH, Klagenfurt am Wörthersee (AT)

(21) Appl. No.: 19/338,542

(22) Filed: Sep. 24, 2025

Related U.S. Application Data
(60) Provisional application No. 63/698,729, filed on Sep. 25, 2024.

(51) Int. Cl. G06Q 30/018; G06Q 50/06; H04N 19/14

(52) U.S. Cl. CPC G06Q 30/018; G06Q 50/06; H04N 19/14

(57) ABSTRACT

Techniques relating to video encoding energy and greenhouse gas emission prediction are disclosed. A system for video encoding energy and greenhouse gas emission prediction includes a video analyzer, an energy predictor module, a carbon data source, and a carbon emissions calculator. The system may be configured to carry out a method that includes extracting complexity features from a video segment, predicting energy consumption for video encoding the video segment on a cloud instance using a machine learning (ML) model, receiving carbon intensity data, cloud instance type data, and region (i.e., country or set of countries) data, and calculating greenhouse gas (e.g., CO₂) emissions based on predicted energy consumption and carbon intensity data. Both fossil fuel and renewable energy sources may be accounted for, along with power imports and exports using a peer-reviewed flow-tracing methodology. The ML model may use one or both of ensemble-based and linear regression methods.

### CROSS-REFERENCE TO RELATED APPLICATIONS

This application claims the benefit of U.S. Provisional Patent Application No. 63/698,729 entitled “Video Encoding Energy and CO2 Emission Prediction,” filed Sep. 25, 2024, the contents of which are hereby incorporated by reference in their entirety.

### BACKGROUND OF INVENTION

In the context of rising environmental concerns, the ubiquitous use of digital media has resulted in the need for excessive resources to support the content consumption of billions of people. Video content, in particular, is extremely popular, with streaming accounting for approximately 66% of global internet traffic—a number that is only expected to rise even higher in the coming years. To ensure that these videos are available to viewers, they must first undergo an encoding process. This is typically computationally intensive and done in large data centers. Cloud computing providers have become the backbone of modern computing infrastructure due to their ability to handle complex video encoding tasks through readily available and scalable resources.

With climate change on the rise, businesses and politicians alike are becoming more aware of its potential consequences. As a result, the energy consumption and associated carbon footprint of data centers have become a global concern. Two factors are very relevant in this matter. The first is the hardware being used. Depending on the specific configuration, there can be significant variation in energy consumption. Second, the location of the data centers is relevant, as different countries have different levels of carbon intensity. Carbon intensity is a measurement of the amount of CO₂ emissions per kilowatt-hour of electricity consumed. Even within the same country, considerable variations can occur over a day or at other times of the year.

Existing studies have measured the energy used for the central processing unit's (CPU's) cache and evaluated energy consumption for videos across different presets, but lack analysis of a video's complexity. Other studies analyze the impact of encoding parameters on video quality and energy consumption for High-Efficiency Video Coding (HEVC) and Advanced Video Coding (AVC). They categorize input videos by resolution, excluding other video complexity metrics, emphasizing the relationship between video resolution and energy efficiency for different encoding presets. Still others have studied the energy usage of different encoders on a locally isolated server, developed models for energy consumption during encoding, investigated performance of energy prediction models based on quantization parameter and frame rate, and so on. However, none of these existing studies and methods consider video complexity along with energy consumption to predict encoding energy of a video segment, nor have they tested on different types of cloud computing instances.

Therefore, systems and methods for video encoding energy and greenhouse gas emission prediction is desirable.

### BRIEF SUMMARY

A system and method are disclosed for video encoding energy and greenhouse gas emission prediction. A method for video encoding energy and greenhouse gas emission prediction may include: receiving, by a video analyzer, a video content comprising a video segment; extracting, by the video analyzer, complexity features from the video segment; predicting, by an energy predictor module, energy consumption for video encoding the video segment on a cloud instance using a machine learning (ML) model; receiving carbon intensity data for a country where the cloud instance is located; calculating greenhouse gas emissions based on the predicted energy consumption and the carbon intensity data, the greenhouse gas emissions comprising at least CO₂ emissions for a given region; and outputting the calculated greenhouse gas emissions. In some examples, the method also includes outputting the predicted energy consumption.

In some examples, the complexity features comprise one, or a combination, of a spatial complexity of a frame in the video segment, the temporal complexity of the frame, the brightness of the frame, the average U chroma component of the frame, the average U chroma texture of the frame, the average V chroma component of the frame, and the average V chroma texture of the frame. In some examples, the predicting energy consumption for video encoding the video segment is based on the complexity features.

In some examples, the method also includes receiving, by the energy predictor module, an instance type and a set of encoding parameters. In some examples, the set of encoding parameters comprises one, or a combination, of a codec, a bitrate, and a resolution. In some examples, the instance type comprises a type of AWS EC2 instances.

In some examples, the carbon intensity data is based on a mix of different energy sources. In some examples, the different energy sources comprise one or both of a fossil fuel energy source and a renewable energy source. In some examples, the carbon intensity data accounts for power imports and exports using a peer-reviewed flow-tracing methodology. In some examples, the carbon intensity data comprises one, or a combination, of live data, historical data, and forecast data.

In some examples, the ML model comprises a prediction model using ensemble-based methods. In some examples, the ML model comprises a prediction model using linear regression methods. In some examples, the method includes preprocessing inputs to the ML model using transformers. In some examples, the carbon intensity data comprises a measure of the amount of CO₂ emissions per kilowatt-hour of electricity consumed. In some examples, the calculating greenhouse gas emissions comprises multiplying the carbon intensity data by the predicted energy consumption.

A system for video encoding energy and greenhouse gas emission prediction may include: a memory comprising non-transitory computer-readable storage medium configured to store video data and carbon intensity data; one or more processors configured to execute instructions stored on the non-transitory computer-readable storage medium to: receive, by a video analyzer, a video content comprising a video segment; extract, by the video analyzer, complexity features from the video segment; predict, by an energy predictor module, energy consumption for video encoding the video segment on a cloud instance using a machine learning (ML) model; receive the carbon intensity data for a country where the cloud instance is located; calculate greenhouse gas emissions based on the predicted energy consumption and the carbon intensity data, the greenhouse gas emissions comprising at least CO2 emissions for a given region; and output the calculated greenhouse gas emissions.

### BRIEF DESCRIPTION OF THE DRAWINGS

Various non-limiting and non-exhaustive aspects and features of the present disclosure are described hereinbelow with references to the drawings, wherein:

FIG. 1 is a simplified block diagram illustrating an exemplary video encoding energy and greenhouse gas emission prediction (VEEP) architecture, in accordance with one or more embodiments.

FIG. 2 is a flow diagram illustrating an exemplary method for video encoding energy and greenhouse gas emission prediction, in accordance with one or more embodiments.

FIG. 3A is a simplified block diagram of an exemplary computing system configured to implement the system shown in FIG. 1 and to perform steps of the method illustrated in FIG. 2, in accordance with one or more embodiments.

FIG. 3B is a simplified block diagram of an exemplary distributed computing system implemented by a plurality of the computing devices, in accordance with one or more embodiments.

FIG. 4 is a line graph showing variances in carbon intensity in exemplary countries across an exemplary 24-hour day, in accordance with one or more embodiments.

FIGS. 5A-5C are bar graphs showing variation in carbon intensity across other factors, in accordance with one or more embodiments.

Like reference numbers and designations in the various drawings indicate like elements. Skilled artisans will appreciate that elements in the Figures are illustrated for simplicity and clarity, and have not necessarily been drawn to scale, for example, with the dimensions of some of the elements in the figures exaggerated relative to other elements to help to improve understanding of various embodiments. Common, well-understood elements that are useful or necessary in a commercially feasible embodiment are often not depicted in order to facilitate a less obstructed view of these various embodiments.

### DETAILED DESCRIPTION

The invention is directed to video encoding energy and greenhouse gas emission prediction. The systems and methods described herein comprise a video encoding energy and greenhouse gas (e.g., CO₂) emission prediction (VEEP) technique, an ML-based scheme to predict energy consumption and CO2 emissions in cloud-based video encoding. The VEEP methodology involves (1) analyzing video to extract its complexity features; (2) predicting energy consumption for video encoding on cloud computing servers (e.g., AWS EC2 instances and other cloud instances) utilizing a machine learning (ML) model; (3) fetching carbon intensity data for the country where the instance is located; (4) calculating greenhouse gas (e.g., CO₂) emissions based on energy consumption and carbon intensity data.

Techniques described herein provide a scheme that can predict the CPU energy consumption (i.e., energy consumption of a central processing unit) during the video encoding process with high accuracy, indicated by an R²-score of 0.96, a mean absolute error (MAE) of 2.41×10⁻⁵ and a mean squared error (MSE) of 1.67×10⁻⁹. In examples, the coefficient of determination (R²) quantifies a percentage of the target variable's variance that the ML model explains, while the mean squared error (MSE) and mean absolute error (MAE) provide insights into the average magnitude of the ML model's errors, with MSE giving more weight to larger errors due to squaring the differences, and MAE presenting a straightforward average of error magnitudes. The CO₂ emissions of encoding a video segment within a given country can be calculated based on its real-time energy consumption mix and carbon intensity. As a result, CO₂ emissions can be reduced by up to 375 times when the type and location of cloud instances are carefully selected.

Embodiments described herein may predict energy consumption on different types of cloud computing instances (e.g., AWS EC2 instances and other cloud instances) rather than on local individual machines. The encoding energy of a video segment for varying instance types considering the complexity of a video's content may be predicted. Then real-time CO₂ emissions for an encoding in different countries may be calculated. In an example, a video segment is 5 seconds long and encoded with HEVC in UHD resolution (3840×2160p) with a frame rate of 24 fps. In an example, videos are stored in a losslessly encoded 8-bit 4:2:0 format, ensuring high fidelity and quality. VCD consists of a wide range of video complexities, and may be used for training and benchmarking ML models as it provides a variety of scenes that can be encountered in real-world use cases. In an example, a video input may be encoded using FFmpeg 5.0.2 with libx265 for HEVC and libx264 for AVC with preset of medium. A dataset may include a selection of six different resolutions 360p, 540p, 720p, 1080p, 1440p, 2160p based on the Apple HLS authoring specification with bitrates of 145, 1600, 3400, 5800, 8100 and 16 800 kb/s.

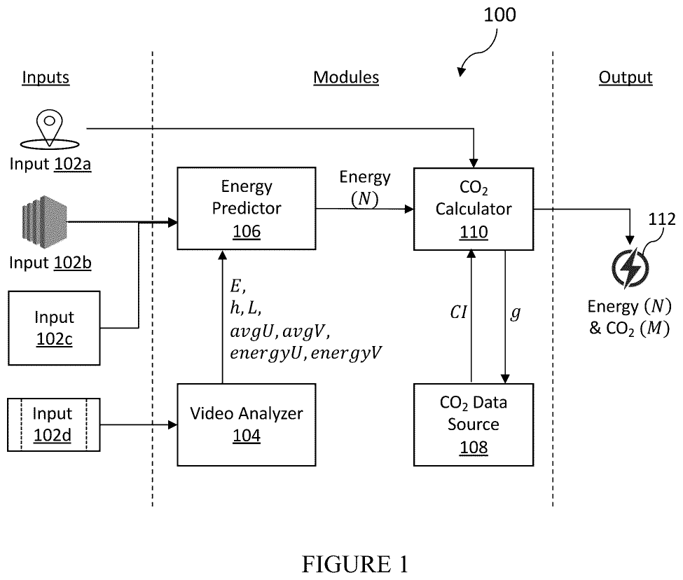

FIG. 1 is a simplified block diagram illustrating an exemplary video encoding energy and greenhouse gas emission prediction (VEEP) architecture, in accordance with one or more embodiments. VEEP aims to estimate energy consumption and CO₂ emissions of the video encoding process. VEEP comprises four modules: video analyzer 104, energy predictor 106, CO₂ data source 108, and CO₂ calculator 110.

In some examples, video analyzer 104 initiates the process by performing a frame-by-frame analysis of an input video 102d. Video analyzer 104 calculates averages for various complexity features across all frames of input video 102d. These features are correlated to the required computational encoding workload. The output includes (a) spatial E and temporal h complexities, (b) brightness of the frame L, and (c) chroma features avgU, energyU, avgV, and energyV. A description of these features is provided in Table 1.

TABLE 1
Notation for video complexity features

| Metric | Description |
|---|---|
| E | Spatial complexity of a frame |
| h | Temporal complexity of a frame |
| L | Brightness of a frame |
| avgU | Average U chroma component of a frame |
| energyU | Average U chroma texture of a frame |
| avgV | Average V chroma component of a frame |
| energyV | Average V chroma texture of a frame |

In an example, a Video Complexity Analyzer (VCA) version 2.0 may be used to extract video complexity features. The VCA may accept raw YUV or Y4M videos as input and may output a file containing a variety of complexity features, as described above.

In some examples, energy predictor 106 comprises a machine learning (ML) model that receives a video's complexity features E, h, L, avgU, energyU, avgV, and energyV from video analyzer 104 along with other inputs 102b-102c (e.g., a type (t) of cloud instance (e.g., such as compute-optimized instances, general purpose instances, memory-optimized instances, and other types of AWS EC2 instance) and encoding parameters (e.g., codec (c), bitrate (b), and resolution (r)), among other possible inputs. The energy predictor 106 model predicts the energy consumption (N) for encoding an input video on a specific cloud (i.e., virtual server) instance type, as may be represented by this equation:

$$N = f ( E , h , L , avgU , energyU , avgV , energyV , c , b , r , t )$$

Various different prediction models may be used (e.g., scikit's sklearn-library (v1.3.2)). In an example, the ML prediction model may use ensemble-based or linear regression methods (e.g., ExtraTreesRegressor, RandomForestRegressor, GradientBoostingRegressor, and AdaBoostRegressor). In an example, sklearn.ensemble may be used, combining multiple models to enhance accuracy and robustness. Additionally, (v) linear regression based on non-negative lease squares from an ML model (e.g., sklearn.linear_model) may be employed. In some examples, the data may be preprocessed using transformers (e.g., StandardScaler, MinMaxScaler, RobustScaler, Normalizer, QuantileTransformer, PowerTransformer, MaxAbsScaler, FunctionTransformer, PolynomialFeatures) available in a preprocessing module (e.g., the sklearn.preprocessing module). Data preprocessors and regressors are combined into a pipeline (e.g., sklearn.pipeline module) for easier integration and streamlined management of data transformation and modeling processes within the code. Predictions may be based on features defined in Table 2:

TABLE 2
Features used for training and testing
an energy predictor ML model

| Feature | Range |
|---|---|
| Video complexity | E, h, L, avgU, energyU, avgV, energyV |
| c | AVC, HEVC |
| r [pixel] | 360, 540, 720, 1080, 1440, 2160 |
| b [kb/s] | 145, 1600, 3400, 5800, 8100, 16800 |
| t | c5.2xlarge, c5.4xlarge, c5.9xlarge, c5.large, |
| | c5.xlarge, m5.2xlarge, r5.2xlarge |

CO₂ calculator 110 may be configured to estimate carbon emissions following an energy prediction by energy predictor 106. CO₂ calculator 110 fetches live carbon intensity (CI) data from CO₂ data source 108. CO₂ calculator 110 then calculates (e.g., estimates) CO₂ emissions (M) for the specified instance type (t) (e.g., input 102b) in a given region, country, or set of countries (e.g., input 102a), denoted by (g), by multiplying CI by predicted CPU energy consumption N, as may be represented by the following equation:

$$M = \{ N \times CI ( g ) \vert {∀}_{g} ∈ G \}$$

CO₂ data source 108 module may access an application programmable interface (API) that provides real-time carbon intensity data (CI) for various countries (e.g., Electricity Maps API). In some examples, CI may comprise a measure of the amount of CO₂ emissions per kilowatt-hour of electricity consumed. CO₂ data source 108 may account for a mix of different energy sources used to produce electricity, such as fossil fuels and renewables. Additionally, the system may include the influence of power imports and exports between countries using a peer-reviewed flow-tracing methodology. By combining real-time consumption data with regional emission factors, the API may offer a detailed representation of carbon intensity, including a wide range of live, historical, and forecast data. In examples, the API may supply data on energy consumption, production, power mix import/export, and CO₂ emissions of countries around the world. A script (e.g., Python 3.10 script) may retrieve the data, the script output containing the energy and carbon intensity information for a country or set of predetermined countries.

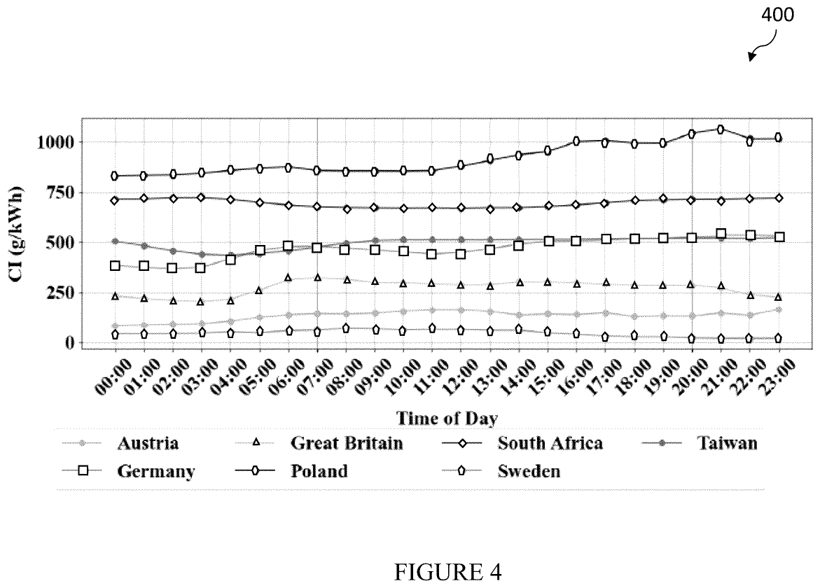

Carbon intensity (CI) may vary in many countries throughout a 24-hour day. FIG. 4 is a line graph showing variances in carbon intensity in exemplary countries across an exemplary 24-hour day, in accordance with one or more embodiments. The exemplary countries include Austria, Germany, Great Britan, Poland, South Africa, Sweden, and Taiwan. The data shows notable fluctuations in CI within 24 hours in these countries. For example, Poland, which largely relies on fossil fuels, has the highest variance in CI (Variance=6109.09), with values spanning from 830 g/kWh to 1066 g/kWh. Still, countries like Austria and Sweden, known for their substantial use of renewable energy sources such as hydropower and wind, also exhibit considerable variances. Such variability in C/may be a common feature across different energy systems.

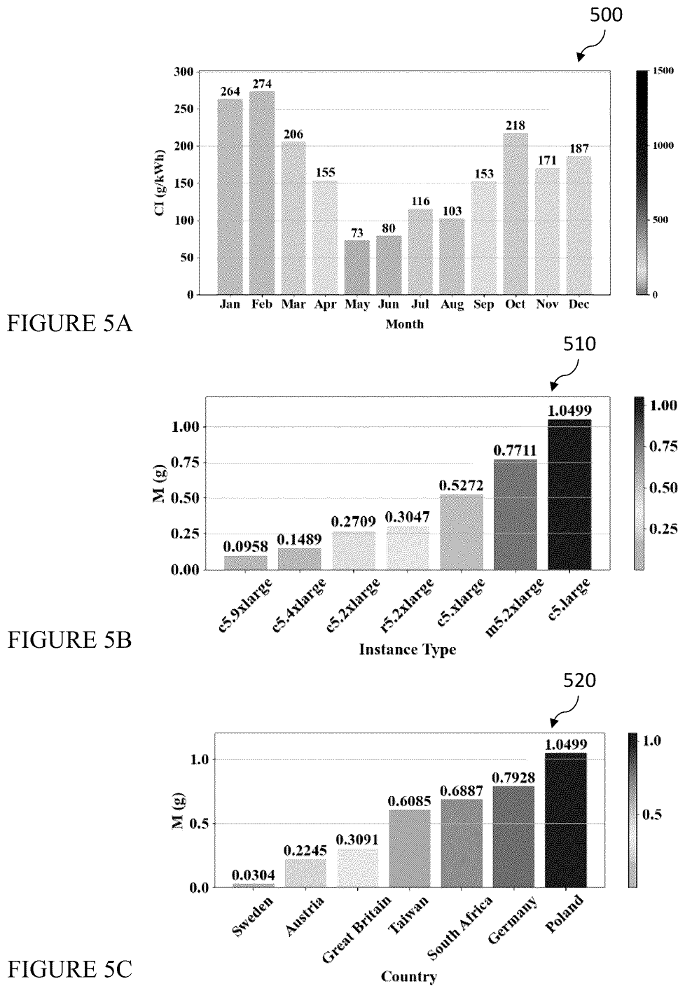

FIGS. 5A-5C are bar graphs showing variation in carbon intensity across other factors, in accordance with one or more embodiments. In FIG. 5A, seasonal CI variations are shown in graph 500 throughout an exemplary year in an exemplary country, with the lowest levels of emissions recorded from May to August, and the highest emissions reached in winter months (e.g., January to February). In FIG. 5B, CI variation between different cloud instance types (t) on a given day in a given country is shown in graph 510. In this example, the most efficient instance can encode a given video segment with N=0.099 Wh and M=0.1 g, while the least efficient instance encodes the given video segment with N=1.085 Wh and M=1.05 g, an increase of 950%. In FIG. 5C, variations in CO2 emissions for a given video segment on a given day for different countries with a given instance type are shown in graph 520. As shown, there is significant difference between countries when all other factors are kept the same, with the difference between Sweden and Poland being a 3354% increase.

As shown in FIG. 1, output 112 may comprise CO₂ emissions (M) for the specified instance type (t) (e.g., input 102b) in a given region, country, or set of countries (e.g., input 102a), as well as other data (e.g., predicted CPU energy consumption N).

### Example Methods

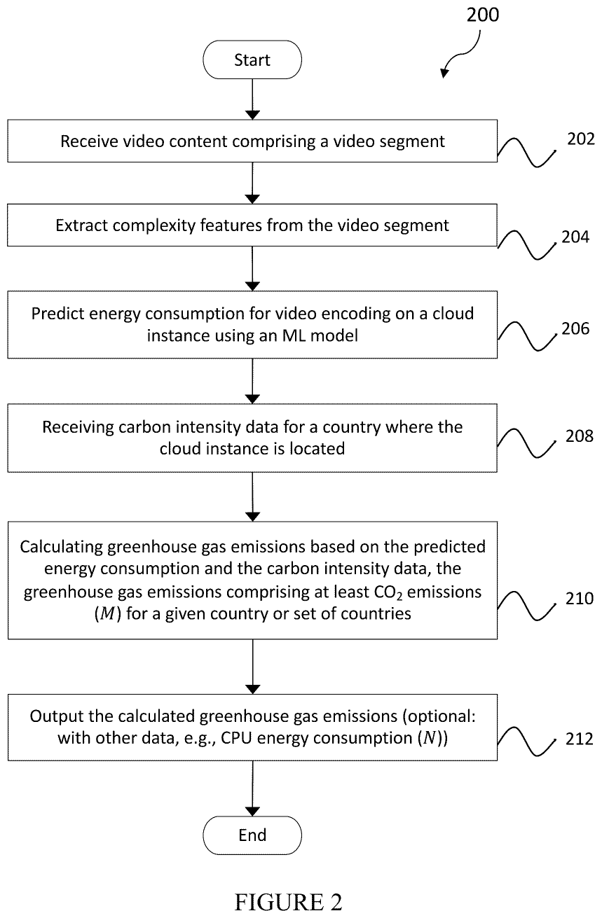

FIG. 2 is a flow diagram illustrating an exemplary method for video encoding energy and greenhouse gas emission prediction, in accordance with one or more embodiments. Method 200 may begin with receiving (e.g., ingesting) video content at step 202 (e.g., by video analyzer 104), the video content comprising a video segment. Complexity features (e.g., E, h, L, avgU, energyU, avgV, and energyV) may be extracted from the video segment at step 204 (e.g., by video analyzer 104). Energy consumption (N) for video encoding the video segment on a cloud instance may be predicted (e.g., by energy predictor 106) using an ML model at step 206. The ML model may receive the extracted complexity features, as well as instance type (t) and encoding parameters (e.g., codec (c), bitrate (b), and resolution (r)), etc.), as inputs. Carbon intensity data (e.g., from CO₂ data source 108) for a country where the cloud instance is located may be received (e.g., by CO₂ calculator 110) at step 208. The carbon intensity data may account for a mix of different energy sources used to produce electricity (e.g., fossil fuels, renewables), as well as the influence of power imports and exports between countries using a peer-reviewed flow-tracing methodology, to provide a detailed representation of carbon intensity (CI), including a wide range of live, historical, and forecast data. Greenhouse gas emissions may be calculated based on the predicted energy consumption and the carbon intensity data at step 210, the greenhouse gas emissions comprising at least CO₂ emissions (M) for a given country, region, or set of countries. The calculated greenhouse gas emissions may be output at step 212, optionally along with other data (e.g., predicted CPU energy consumption N).

### Example Computing Systems

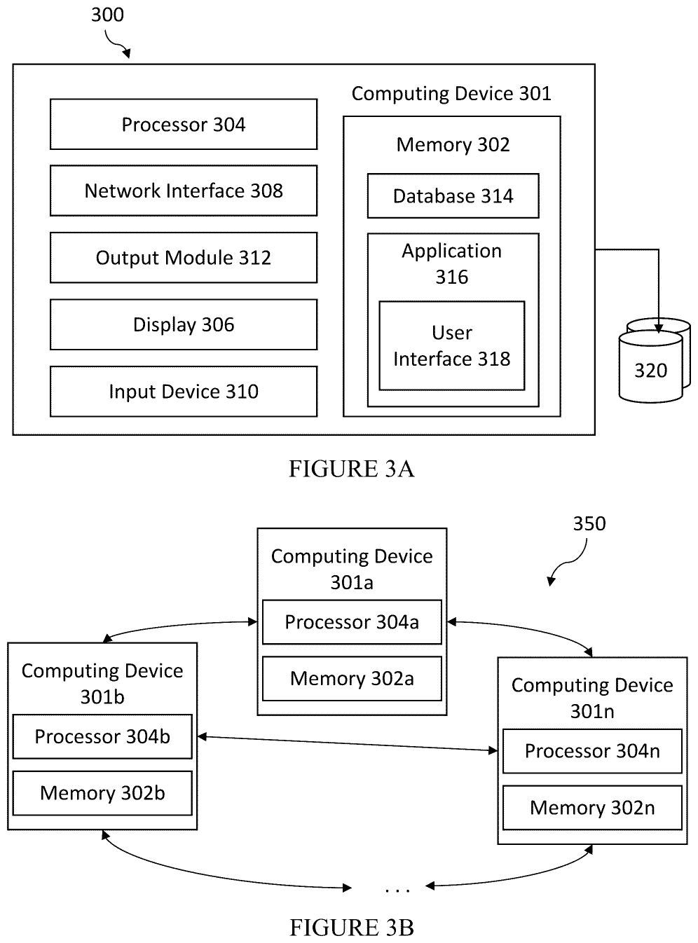

FIG. 3A is a simplified block diagram of an exemplary computing system configured to implement the system shown in FIG. 1 and to perform steps of the method illustrated in FIG. 2, in accordance with one or more embodiments. In one embodiment, computing system 300 may include computing device 301 and storage system 320. Storage system 320 may comprise a plurality of repositories and/or other forms of data storage, and it also may be in communication with computing device 301. In another embodiment, storage system 320, which may comprise a plurality of repositories, may be housed in one or more of computing device 301. In some examples, storage system 320 may store video data (e.g., frames, segments, extracted features, greenhouse emissions data, etc.), codecs, user preferences, instructions, programs, ML models, and other various types of information as described herein. This information may be retrieved or otherwise accessed by one or more computing devices, such as computing device 301, in order to perform some or all of the features described herein. Storage system 320 may comprise any type of computer storage, such as a hard-drive, memory card, ROM, RAM, DVD, CD-ROM, write-capable, and read-only memories. In addition, storage system 320 may include a distributed storage system where data is stored on a plurality of different storage devices, which may be physically located at the same or different geographic locations (e.g., in a distributed computing system such as system 350 in FIG. 3B). Storage system 320 may be networked to computing device 301 directly using wired connections and/or wireless connections. Such network may include various configurations and protocols, including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Computing device 301 also may include a memory 302. Memory 302 may comprise a storage system configured to store a database 314 and an application 316. Application 316 may include instructions which, when executed by a processor 304, cause computing device 301 to perform various steps and/or functions, as described herein. Application 316 further includes instructions for generating a user interface 318 (e.g., graphical user interface (GUI)). Database 314 may store various algorithms and/or data, including neural networks, ML models, data regarding encoding, video content, complexity features, cloud instances, user preferences, greenhouse gas emissions, among other types of data. Memory 302 may include any non-transitory computer-readable storage medium for storing data and/or software that is executable by processor 304, and/or any other medium which may be used to store information that may be accessed by processor 304 to control the operation of computing device 301.

Computing device 301 may further include a display 306, a network interface 308, an input device 310, and/or an output module 312. Display 306 may be any display device by means of which computing device 301 may output and/or display data. Network interface 308 may be configured to connect to a network using any of the wired and wireless short range communication protocols described above, as well as a cellular data network, a satellite network, free space optical network and/or the Internet. Input device 310 may be a mouse, keyboard, touch screen, voice interface, and/or any or other hand-held controller or device or interface by means of which a user may interact with computing device 301. Output module 312 may be a bus, port, and/or other interface by means of which computing device 301 may connect to and/or output data to other devices and/or peripherals.

In one embodiment, computing device 301 is a data center or other control facility (e.g., configured to run a distributed computing system as described herein), and may communicate with a media playback device or other video player or client device. As described herein, system 300, and particularly computing device 301, may be used for encoding video, extracting, analyzing, and generating metadata, determining advertisement placement, and otherwise implementing steps in live advertising management, as described herein. Various configurations of system 300 are envisioned, and various steps and/or functions of the processes described herein may be shared among the various devices of system 300 or may be assigned to specific devices.

FIG. 3B is a simplified block diagram of an exemplary distributed computing system implemented by a plurality of the computing devices, in accordance with one or more embodiments. System 350 may comprise two or more computing devices 301a-n. In some examples, each of 301a-n may comprise one or more of processors 304a-n, respectively, and one or more of memory 302a-n, respectively. Processors 304a-n may function similarly to processor 304 in FIG. 3A, as described above. Memory 302a-n may function similarly to memory 302 in FIG. 3A, as described above.

While specific examples have been provided above, it is understood that the present invention can be applied with a wide variety of inputs, thresholds, ranges, and other factors, depending on the application. For example, the time frames, rates, ratios, and ranges provided above are illustrative, but one of ordinary skill in the art would understand that these time frames and ranges may be varied or even be dynamic and variable, depending on the implementation.

As those skilled in the art will understand a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements. The methods or flow charts provided may be implemented in a computer program, software, or firmware tangibly embodied in a computer-readable storage medium for execution by a general-purpose computer or processor.

Examples of computer-readable storage mediums include a read only memory (ROM), random-access memory (RAM), a register, cache memory, semiconductor memory devices, magnetic media such as internal hard disks and removable disks, magneto-optical media, and optical media such as CD-ROM disks.

Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, or any combination of thereof.

What is claimed is:

1. A method for video encoding energy and greenhouse gas emission prediction comprising:
receiving, by a video analyzer, a video content comprising a video segment;
extracting, by the video analyzer, complexity features from the video segment;
predicting, by an energy predictor module, energy consumption for video encoding the video segment on a cloud instance using a machine learning (ML) model;
receiving carbon intensity data for a country where the cloud instance is located;
calculating greenhouse gas emissions based on the predicted energy consumption and the carbon intensity data, the greenhouse gas emissions comprising at least CO₂ emissions for a given region; and
outputting the calculated greenhouse gas emissions.

2. The method of claim 1, further comprising outputting the predicted energy consumption.

3. The method of claim 1, wherein the complexity features comprise one, or a combination, of a spatial complexity of a frame in the video segment, the temporal complexity of the frame, the brightness of the frame, the average U chroma component of the frame, the average U chroma texture of the frame, the average V chroma component of the frame, and the average V chroma texture of the frame.

4. The method of claim 1, wherein the predicting energy consumption for video encoding the video segment is based on the complexity features.

5. The method of claim 1, further comprising receiving, by the energy predictor module, an instance type and a set of encoding parameters.

6. The method of claim 5, wherein the set of encoding parameters comprises one, or a combination, of a codec, a bitrate, and a resolution.

7. The method of claim 5, wherein the instance type comprises a type of AWS EC2 instance.

8. The method of claim 1, wherein the carbon intensity data is based on a mix of different energy sources.

9. The method of claim 8, wherein the different energy sources comprise one or both of a fossil fuel energy source and a renewable energy source.

10. The method of claim 1, wherein the carbon intensity data accounts for power imports and exports using a peer-reviewed flow-tracing methodology.

11. The method of claim 1, wherein the carbon intensity data comprises one, or a combination, of live data, historical data, and forecast data.

12. The method of claim 1, wherein the ML model comprises a prediction model using ensemble-based methods.

13. The method of claim 1, wherein the ML model comprises a prediction model using linear regression methods.

14. The method of claim 1, further comprising preprocessing inputs to the ML model using transformers.

15. The method of claim 1, wherein the carbon intensity data comprises a measure of the amount of CO₂ emissions per kilowatt-hour of electricity consumed.

16. The method of claim 1, wherein the calculating greenhouse gas emissions comprises multiplying the carbon intensity data by the predicted energy consumption.

17. A system for video encoding energy and greenhouse gas emission prediction comprising:
a memory comprising non-transitory computer-readable storage medium configured to store video data and carbon intensity data;
one or more processors configured to execute instructions stored on the non-transitory computer-readable storage medium to:
receive, by a video analyzer, a video content comprising a video segment;
extract, by the video analyzer, complexity features from the video segment;
predict, by an energy predictor module, energy consumption for video encoding the video segment on a cloud instance using a machine learning (ML) model;
receive the carbon intensity data for a country where the cloud instance is located;
calculate greenhouse gas emissions based on the predicted energy consumption and the carbon intensity data, the greenhouse gas emissions comprising at least CO2 emissions for a given region; and
output the calculated greenhouse gas emissions.
